(19) United States
(12) Patent Application Publication
(10) Pub. No.: US 2019/0317634 A1
(43) Pub. Date: Oct. 17, 2019

(54) PRESSURE SENSITIVE DISPLAY DEVICE

(71) Applicant: SAMSUNG DISPLAY CO., LTD., YONGIN-SI (KR)

(72) Inventor: HEEKWON LEE, Asan-si (KR)

(21) Appl. No.: 16/193,499

(22) Filed: Nov. 16, 2018

(30) Foreign Application Priority Data
Apr. 11, 2018 (KR) 10-2018-0042279

(51) Int. Cl. G06F 3/041; G06F 3/044

(52) U.S. Cl. CPC G06F 3/0414; G06F 3/044; G06F 3/0416

(57) ABSTRACT

The present invention is directed to a display device capable of accurately and efficiently calculating a position where pressure is applied, the display device including: a display panel having a display area and a non-display area; a window disposed on one surface of the display panel; a touch sensing unit disposed between the display panel and the window; a pressure sensing unit disposed on another surface of the display panel and including a plurality of pressure sensors spaced apart from each other; and a pressure sensing driver configured to receiving a signal detected from the pressure sensing unit and to output pressure sensing information.

### CROSS-REFERENCE TO RELATED APPLICATION

This application claims priority under 35 U.S.C. § 119 to Korean Patent Application No. 10-2018-0042279, filed on Apr. 11, 2018, in the Korean Intellectual Property Office (KIPO), the disclosure of which is incorporated by reference herein in its entirety.

### 1. TECHNICAL FIELD

Embodiments of the present invention relate to a display device, and more particularly, to a display device including a plurality of pressure sensors.

### 2. DISCUSSION OF RELATED ART

With the development of the information society, the demand for display devices configured to display images increases substantially. For example, there is a demand for various types of display devices, such as liquid crystal display (“LCD”) devices, plasma display panel (“PDP”) devices, and organic light emitting diode (“OLED”) display devices.

Some display devices, including mobile display devices such as a smartphone, a tablet, and the like, and also including mid- and large-sized display devices such as a smart television, offer touch-type input processing capabilities configured according to user convenience and device characteristics.

Such display devices capable of touch-type input processing may provide a variety of functions to meet the diverse and growing demands of users. However, physical buttons may be insufficiently sensitive, prone to failure, and they may interfere with the display (i.e., limit the size of the display).

It is to be understood that this discussion of related art is intended to provide useful background for understanding the technology and as such may include ideas, concepts or recognitions that were known or appreciated by those skilled in the pertinent art prior to the effective filing date of subject matter disclosed herein.

### SUMMARY

Embodiments of the present invention may be directed to a display device for accurately and efficiently calculating a position where pressure is applied.

According to an embodiment, a display device includes: a display panel having a display area and a non-display area: a window disposed on one surface of the display panel; a touch sensing unit disposed between the display panel and the window; a pressure sensing unit disposed on another surface of the display panel and including a plurality of pressure sensors spaced apart from each other; and a pressure sensing driver configured to receive a signal detected from the pressure sensing unit and to output pressure sensing information.

The display device may further include a flexible printed circuit board that includes a plurality of first wirings connecting the plurality of pressure sensors and the pressure sensing driver. The pressure sensing driver may be disposed on the flexible printed circuit board.

The flexible printed circuit board may overlap the plurality of pressure sensors.

The display device may further include a protective layer disposed between the pressure sensing unit and the display panel and overlapping the flexible printed circuit board.

The pressure sensing driver may be configured to detect a pressure sensor to which a pressure is applied among the plurality of pressure sensors and calculate a position to which the pressure is applied.

The pressure sensing unit may overlap at least a part of the display area.

The pressure sensing unit may overlap a button area of the display area.

The display device may further include a height difference compensating unit disposed at an area other than the button area on a plane between the plurality of pressure sensors.

Each of the plurality of pressure sensors may include: a first sensing electrode; a second sensing electrode opposing the first sensing electrode; and an elastic member disposed between the first sensing electrode and the second sensing electrode. Each of the plurality of pressure sensors may be configured to output a current signal to the pressure sensing driver.

One of the first sensing electrode and the second sensing electrode may be unitarily formed, and the other may be formed including a plurality of electrodes.

Each of the plurality of pressure sensors may have an area substantially equal to or less than about 25 mm².

The elastic member may include one of an elastic pad, a double-sided adhesive foam pad, and a spring.

The display device may further include a case accommodating the display panel, the touch sensing unit, and the pressure sensing unit.

According to an embodiment, a display device includes: a display panel having a display area and a non-display area; a pressure sensing unit including a plurality of pressure sensors spaced apart from each other; and a pressure sensing driver connected to the pressure sensing unit. Each of the plurality of pressure sensors has an area substantially equal to or less than about 25 mm².

At least two of the plurality of pressure sensors that are adjacent to each other may output a current signal substantially simultaneously.

The pressure sensing driver may be configured to detect a pressure sensor to which a pressure is applied among the plurality of pressure sensors and calculate a position to which the pressure is applied.

The pressure sensing driver may be configured to calculate the position to which the pressure is applied based on a magnitude of the current signal output from the plurality of pressure sensors.

The display device may further include a flexible printed circuit board that includes a plurality of first wirings connecting the plurality of pressure sensors and the pressure sensing driver. The pressure sensing driver may be disposed on the flexible printed circuit board.

Each of the plurality of pressure sensors may include: a first sensing electrode; a second sensing electrode opposing the first sensing electrode; and an elastic member disposed between the first sensing electrode and the second sensing electrode. Each of the plurality of pressure sensors may be configured to output a current signal to the pressure sensing driver.

One of the first sensing electrode and the second sensing electrode may be unitarily formed, and the other may be formed including a plurality of electrodes.

The foregoing is illustrative only and is not intended to be in any way limiting. In addition to the illustrative aspects, embodiments and features described above, further aspects, embodiments and features will become apparent by reference to the drawings and the following detailed description.

### BRIEF DESCRIPTION OF THE DRAWINGS

A more complete appreciation of the present invention will become more apparent by describing in detail embodiments thereof with reference to the accompanying drawings, wherein:

FIG. 1 is a perspective view illustrating a display device according to an embodiment of the present invention;

FIG. 2 is a plan view illustrating a display device according to an embodiment of the present invention;

FIG. 3 is a view enlarging portion A in FIG. 2;

FIG. 4 is a cross-sectional view taken along line I-I′ of FIG. 3;

FIG. 5 is a view illustrating a state where a pressure is applied to a display device according to an embodiment of the present invention;

FIG. 6 is a cross-sectional view taken along line II-II′ of FIG. 5;

FIG. 7 is a partial plan view illustrating a display device according to an embodiment of the present invention; and

FIG. 8 is a view enlarging portion B in FIG. 7.

### DETAILED DESCRIPTION

Embodiments will now be described more fully hereinafter with reference to the accompanying drawings. Although the invention may be modified in various manners and have several embodiments, embodiments are illustrated in the accompanying drawings and will be mainly described in the specification. However, the scope of the invention is not limited to the embodiments and should be construed as including all the changes, equivalents and substitutions included in the spirit and scope of the invention.

In the drawings, thicknesses of a plurality of layers and areas are illustrated in an enlarged manner for clarity and ease of description thereof. When a layer, area, or plate is referred to as being “on” another layer, area, or plate, it may be directly on the other layer, area, or plate, or intervening layers, areas, or plates may be present therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or intervening layers, areas, or plates may be present therebetween. Conversely, when a layer, area, or plate is referred to as being “directly below” another layer, area, or plate, intervening layers, areas, or plates may be absent therebetween.

The spatially relative terms “below”, “beneath”, “lower”, “above”, “upper” and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in the other direction and thus the spatially relative terms may be interpreted differently depending on the orientations.

Throughout the specification, when an element is referred to as being “connected” to another element, the element is “directly connected” to the other element, or “electrically connected” to the other element with one or more intervening elements interposed therebetween. It will be further understood that the terms “comprises,” “including,” “includes” and/or “including,” when used in this specification, specify the presence of stated features, integers, steps, operations, elements and/or components, but do not preclude the presence or addition of one or more other features, integers, steps, operations, elements, components and/or groups thereof.

It will be understood that, although the terms “first.” “second.” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of variation for the particular value as determined by one of ordinary skill in the art, considering the measurement in question and the error associated with measurement of the particular quantity (i.e., the limitations of the measurement system). For example, “about” may mean within one or more standard variations, or within ±30%, 20%, 10%, 5% of the stated value.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Some of the parts which are not associated with the description may not be provided in order to specifically describe embodiments of the present invention and like reference numerals refer to like elements throughout the specification.

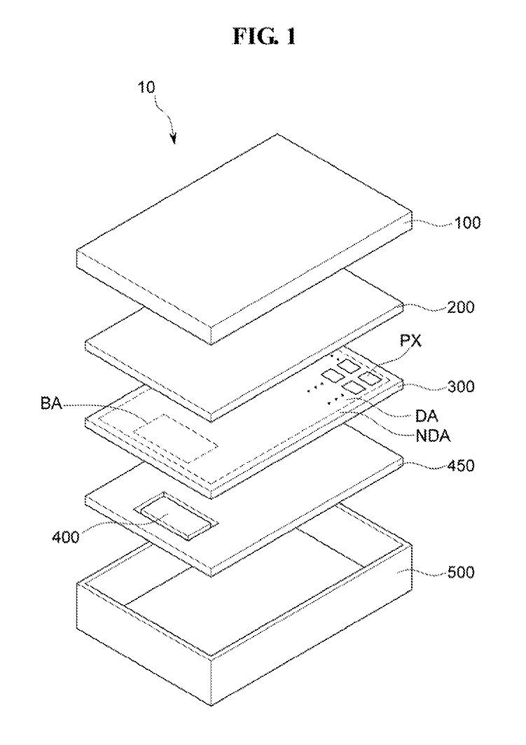

Hereinafter, a display device according to an embodiment of the present invention will be described with reference to FIGS. 1 to 6.

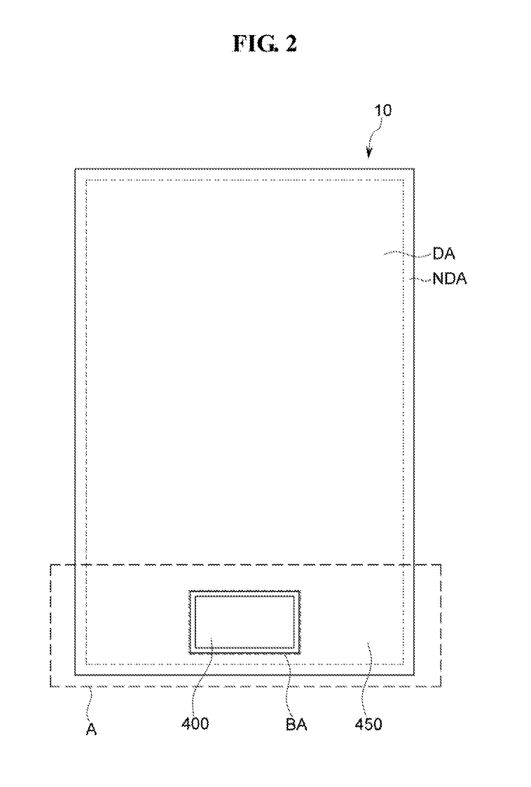

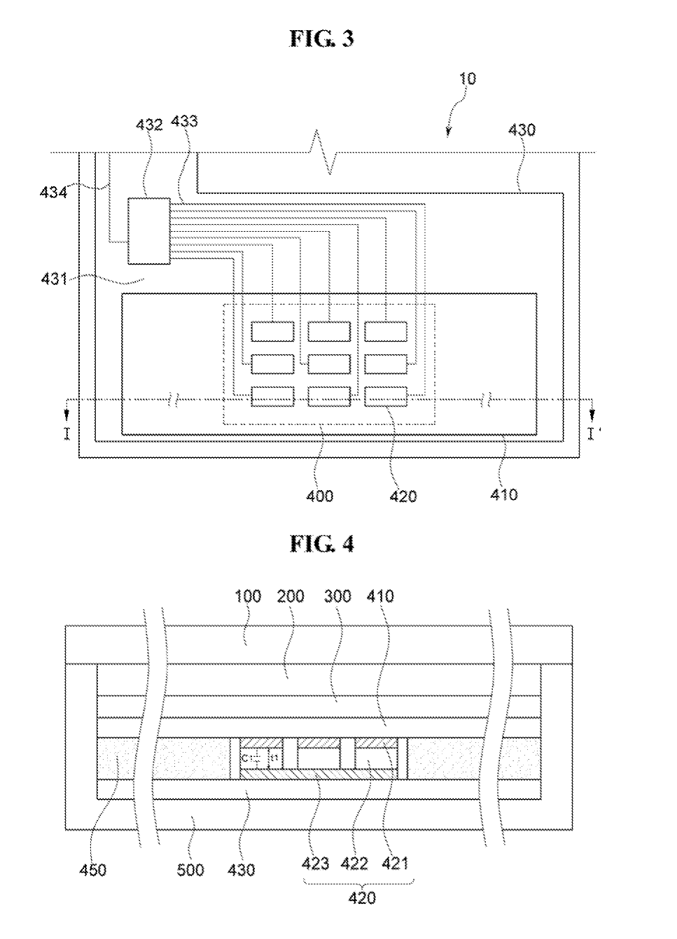

FIG. 1 is a perspective view illustrating a display device 10 according to an embodiment of the present invention, FIG. 2 is a plan view illustrating a display device 10 according to an embodiment of the present invention, FIG. 3 is a view enlarging portion A in FIG. 2, and FIG. 4 is a cross-sectional view taken along line I-I′ of FIG. 3.

Referring to FIGS. 1 and 2, the display device 10, according to an embodiment of the present invention, includes a window 100, a touch sensing unit 200, a display panel 300, a pressure sensing unit 400, a pressure sensing driver (not illustrated), and a case 500.

The window 100 may be a reinforced coating film on which a tempered glass or reinforced coating layer is disposed. For example, the window 100 may be a transparent film including one of polyethylene naphthalate (PEN), polyethylene terephthalate (PET), polycarbonate (PC), and polystyrene sulfonate (PSS). However, embodiments are not limited thereto, and the window 100 may be a film including a synthetic resin that can be reinforced. In addition, the reinforced coating layer may be formed by coating of a resin including silicon (Si) or ceramic, or may be formed through vacuum deposition.

The touch sensing unit 200 is disposed between the window 100 and the display panel 300. As illustrated in the drawings, the touch sensing unit 200 may be formed separately from the display panel 300, or may be formed integrally with the display panel 300 into a unitary structure.

Although not illustrated, the touch sensing unit 200 may include a plurality of touch sensors. In such an embodiment, the plurality of touch sensors may include at least one of a capacitive touch sensor, a pressure sensitive touch sensor, an optical touch sensor, and an ultrasonic touch sensor.

The display panel 300 may be one of an LCD panel, an OLED display panel, a PDP, or an electrophoretic display panel.

The display panel 300 according to an embodiment of the present invention has a display area DA and a non-display area NDA.

The display area DA is an area in which pixels PX are arranged so that images are displayed, and the non-display area NDA is an area in which no image is displayed because the pixels PX are not arranged therein and may surround the display area DA.

According to an embodiment of the present invention, the display area DA may include a button area BA. The button area BA is an area that overlaps the pressure sensing unit 400. In some cases, unlike the example illustrated in FIG. 1, the button area BA may be provided in a position corresponding to a conventional physical button in the non-display area NDA. For example, the button area BA may be provided at a position corresponding to the home button of a smartphone.

A protective layer 410 is disposed below the display panel 300. The protective layer 410 may include one or more layers selected from various inorganic layers and organic layers. The protective layer 410 serves to substantially prevent unnecessary elements such as impurities or moisture from penetrating into the pressure sensing unit 400 and interfering with the operation of the display device 10. However, the protective layer 410 is not necessarily required, and may be omitted.

Referring to FIG. 2, the pressure sensing unit 400 according to an embodiment of the present invention may overlap the button area BA on a plane of the display area DA.

Referring to FIG. 3, the pressure sensing unit 400 according to an embodiment of the present invention may include a plurality of pressure sensors 420.

The plurality of pressure sensors 420 are disposed between the display panel 300 and the case 500 of FIGS. 1, 4 and 6.

The plurality of pressure sensors 420 may be disposed apart from each other, and may be disposed, for example, in a matrix form. Each pressure sensor 420 may have a quadrangular, square, or polygonal shape and may be arranged within a same plane. However, embodiments are not limited thereto, and each pressure sensor 420 may have various other shapes such as a circle and an ellipse.

According to an embodiment of the present invention, each of the plurality of pressure sensors 420 may have an area substantially equal to or less than about 25 mm².

As illustrated in FIG. 4, each of the plurality of pressure sensors 420 may include a first sensing electrode 421, a second sensing electrode 423, and an elastic member 422. In some cases, two or more of the plurality of pressure sensors 420 may incorporate the same unitarily formed second sensing electrode 423.

The plurality of first sensing electrodes 421 are disposed below the display panel 300. For example, the plurality of first sensing electrodes 421 are disposed between the display panel 300 and the case 500. The plurality of first sensing electrodes 421 may be spaced apart from each other on a same plane. However, embodiments of the present invention are not limited thereto, and the first sensing electrodes 421 may be integrally formed into a unitary structure.

The plurality of first sensing electrodes 421 may include an aluminum-based metal such as aluminum (Al) or an aluminum alloy, a silver-based metal such as silver (Ag) or a silver alloy, a copper-based metal such as copper (Cu) or a copper alloy, or a molybdenum-based metal such as molybdenum (Mo) or a molybdenum alloy. Alternatively, the plurality of first sensing electrodes 421 may include one of chromium (Cr), tantalum (Ta), and titanium (Ti). In addition, the plurality of first sensing electrodes 421 may have a multi-layer structure including at least two conductive layers having different physical properties. Alternatively, the plurality of first sensing electrodes 421 may include a transparent conductive material such as indium tin oxide (ITO) or indium zinc oxide (IZO). In such an embodiment. ITO may be a polycrystalline material or a monocrystalline material, and IZO may also be a polycrystalline material or a monocrystalline material.

The second sensing electrode 423 is disposed between the display panel 300 and the case 500. The second sensing electrode 423 is disposed opposing the first sensing electrode 421 with the elastic member 422 interposed therebetween. The second sensing electrode 423 may be integrally formed into a unitary structure over the entire surface of the button area BA. For example, the second sensing electrode 423 may be disposed overlapping the plurality of first sensing electrodes 421, and may be unitarily formed. However, embodiments of the present invention are not limited thereto, and alternatively, the first sensing electrode 421 may be unitarily formed, and the second sensing electrode 423 may be formed in plural.

The second sensing electrode 423 may include an aluminum-based metal such as aluminum (Al) or an aluminum alloy, a silver-based metal such as silver (Ag) or a silver alloy, a copper-based metal such as copper (Cu) or a copper alloy, or a molybdenum-based metal such as molybdenum (Mo) or a molybdenum alloy. Alternatively, the second sensing electrode 423 may include one of chromium (Cr), tantalum (Ta), and titanium (Ti). In addition, the second sensing electrode 423 may have a multi-layer structure including at least two conductive layers having different physical properties. Alternatively, the second sensing electrode 423 may include a transparent conductive material such as indium tin oxide (ITO) or indium zinc oxide (IZO). In such an embodiment, ITO may be a polycrystalline material or a monocrystalline material, and IZO may also be a polycrystalline material or a monocrystalline material.

Each elastic member 422 is disposed between a first sensing electrode 421 and the second sensing electrode 423. In such an embodiment, the elastic member 422 contacts the first sensing electrode 421 on one surface thereof, and contacts the second sensing electrode 423 on another surface thereof that opposes the one surface.

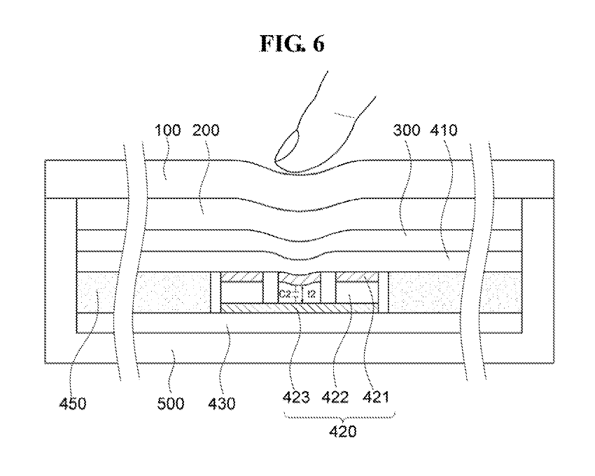

The elastic member 422 includes a material having elasticity. For example, the elastic member 422 may include an elastic pad having elastic restoring force, a double-sided adhesive foam pad, or a spring. For example, the elastic member 422 may include polyurethane (PU). Accordingly, the elastic member 422 is deformed by the pressure applied to the display device, and thus the distance between the first sensing electrode 421 and the second sensing electrode 423 that are disposed with the elastic member 422 therebetween may change (as illustrated in FIG. 6).

The elastic member 422 is an insulator and is insulated from the first sensing electrode 421 and the second sensing electrode 423. In addition, the elastic member 422 insulates the first sensing electrode 421 and the second sensing electrode 423 from each other.

A flexible printed circuit board 430 is disposed between the pressure sensing unit 400 and the case 500.

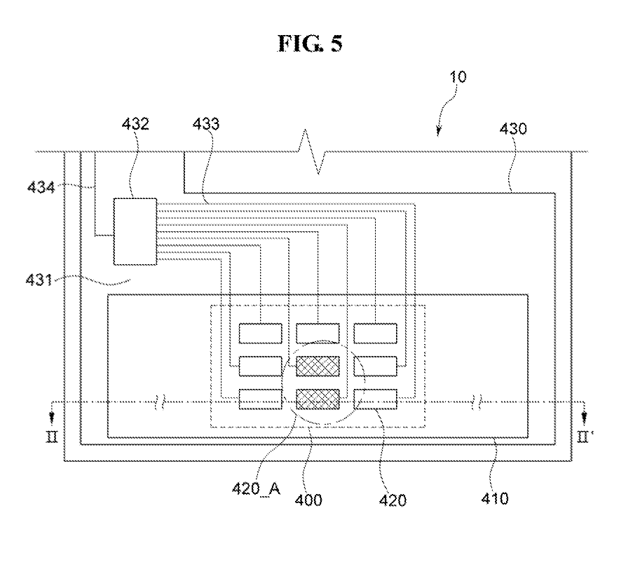

As shown in FIG. 5, the flexible printed circuit board 430 may include a base substrate 431, a plurality of first wirings 433 and a second wiring 434 disposed on the base substrate 431, and a pressure sensing integrated circuit 432 mounted on the base substrate 431. The plurality of first wirings 433 may connect the pressure sensing integrated circuit 432 and each of the plurality of pressure sensors 420 disposed on the base substrate 431. Although not illustrated, the second wiring 434 may be connected to an application processor (“AP”) that receives signals from the touch sensing unit 200, the display panel 300, and the pressure sensing unit 400, and outputs signals corresponding thereto to the touch sensing unit 200, the display panel 300, and the pressure sensing unit 400 to drive the display device.

Each of the plurality of first sensing electrodes 421 disposed on the base substrate 431 may be connected to the pressure sensing integrated circuit 432 mounted on the base substrate 431 through the first wirings 433.

The plurality of pressure sensing integrated circuits 432 include a pressure sensing driver that receives each current flowing through the plurality of pressure sensors 420 to calculate the position of the pressed one of the plurality of pressure sensors and outputs pressure sensing information such as a position signal of the pressed pressure sensor.

Referring again to FIG. 4, a height difference compensating unit 450 may be disposed, in the area other than the button area BA, between the first sensing electrode 421 and the second sensing electrode 423, between the plurality of pressure sensors 420, or between the flexible printed circuit board 430 and the protective layer 410. The height difference compensating unit 450 may compensate for the height difference that may occur due to the elastic member 422, or the plurality of pressure sensors 420. However, embodiments of the present invention are not limited thereto, and the height difference compensating unit 450 may be omitted.

The case 500 accommodates the touch sensing unit 200, the display panel 300, and the pressure sensing unit 400 and supports the window 100. The case 500 may include a bottom portion disposed on a back surface of the touch sensing unit 200, the display panel 300 and the pressure sensing unit 400, and a side portion that encloses side surfaces of the touch sensing unit 200, the display panel 300 and the pressure sensing unit 400.

Hereinafter, a method of sensing the pressure applied to a display device according to an embodiment of the present invention will be described in detail with reference to FIGS. 5 and 6.

FIG. 5 is a view illustrating a state where a pressure is applied to a display device 10 according to an embodiment of the present invention, and FIG. 6 is a cross-sectional view taken along line II-II′ of FIG. 5.

Referring to FIGS. 5 and 6, when a pressure is applied to the display device 10, a pressure sensor 420_A of the plurality of pressure sensors 420 in the button area BA that is located at a portion where the pressure is applied is changed in terms of capacitance. Accordingly, a current flows through the pressure sensor 420_A located at the pressed portion. In such a case, the pressure sensing integrated circuit 432 connected to each of the plurality of pressure sensors 420 detects the current that flows in accordance with the change of the capacitance of each pressure sensor 420 and thereby detects the position of the pressure sensor 420A that experiences a change in capacitance. That is, the capacitance of the pressure sensor 420_A located at the pressed portion changes, the current thus flows therethrough, and the pressure sensing integrated circuit 432 may calculate the position where the pressure is applied by determining which of the pressure sensors 420 were activated. In such an embodiment, if the plurality of pressure sensors 420 according to an embodiment of the present invention are small in size (i.e., relative to a user's finger which may be used to apply the pressure), when the pressure is applied the capacitance of at least two pressure sensors may change, which may enable an accurate identification of the location of the pressure. In some embodiments, the size of the pressure sensors 420 is selected such that they are substantially smaller than the area pressed by a finger, stylus or other means of interacting with the display device 10 (e.g., the pressure sensors 420 may be less than 25 mm²).

When the pressure is applied to the display device 10, the window 100, the touch sensing unit 200, and the display panel 300 disposed on the pressure sensing unit 400 are bent, and the pressure is applied to the elastic member 422. In such an embodiment, the first sensing electrode 421 and the second sensing electrode 423 disposed with the elastic member 422 interposed therebetween may respectively receive constant voltages different from each other.

In such an embodiment, the capacitance formed between the first sensing electrode 421 and the second sensing electrode 423 is defined by the following Equation 1 below.

C=ε(A/t) [Equation 1]

The capacitance C formed between the first sensing electrode 421 and the second sensing electrode 423 is proportional to an area A by which the first sensing electrode 421 and the second sensing electrode 423 oppose each other and a dielectric constant c of the material disposed between the first sensing electrode 421 and the second sensing electrode 423, and is inversely proportional to a distance t between the first sensing electrode 421 and the second sensing electrode 423.

The elastic member 422 to which the pressure is applied has a thickness different from a thickness of the elastic member 422 before the pressure is applied, and the first sensing electrode 421 and the second sensing electrode 423 are spaced apart from each other by a distance t2 different from a distance t1 before the pressure is applied (t1≠t2). Accordingly, the capacitance C2 formed between the first sensing electrode 421 and the second sensing electrode 423 has a value different from a value of the capacitance C1 before the pressure is applied to the display device 10 (C1≠C2). For example, the elastic member 422 to which the pressure is applied has a thickness t2 less than the thickness t1 before the pressure is applied, and the first sensing electrode 421 and the second sensing electrode 423 are spaced apart from each other by a distance t2 less than the distance t1 before the pressure is applied (t1>t2). In such an embodiment, since the capacitance C between the first sensing electrode 421 and the second sensing electrode 423 is inversely proportional to the distance t between the first sensing electrode 421 and the second sensing electrode 423, the capacitance C2 between the first sensing electrode 421 and the second sensing electrode 423 may be greater after the pressure is applied than the capacitance C1 before the pressure is applied (C1<C2).

As the capacitance of the pressure sensor 420_A located at the pressed portion is changed, the current flows through the pressure sensor 420_A located at the pressed portion. That is, the pressure sensor 420_A located at the pressed portion may generate a current signal. The pressure sensing driver that has received the current signal output from the pressure sensor 420_A located at the pressed portion calculates the position where the pressure is applied based on the input current signal, and outputs the pressure sensing information such as the position of the pressure sensor that has been pressed.

According to an exemplary embodiment of the present invention, the pressure sensor 420_A located at the pressed portion may be in plural, and the plurality of pressure sensors 420_A located at the pressed portion may output the current signal substantially simultaneously (e.g., when activated by the same pressure input). In such an exemplary embodiment, the pressure sensing driver may determine the level of the applied pressure on each of the pressure sensors 420_A according to the magnitude of the current signal output from the plurality of pressure sensors 420_A located at the pressed portion, and may therefore determine the position of the pressure more accurately.

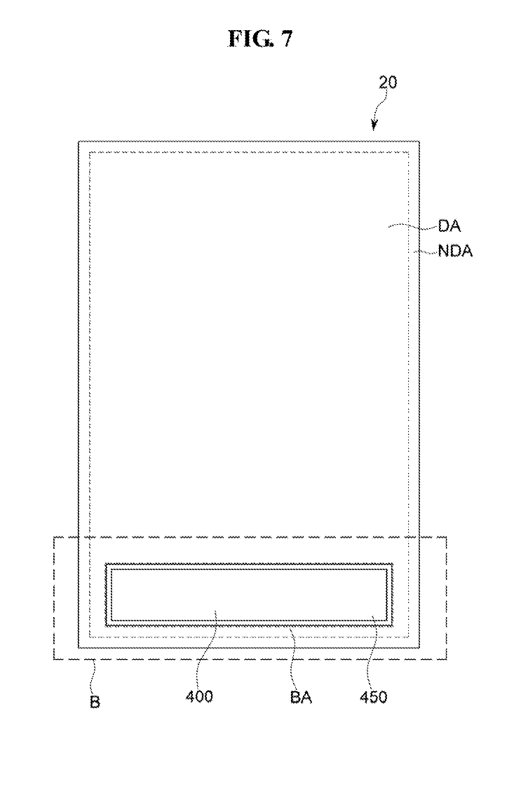

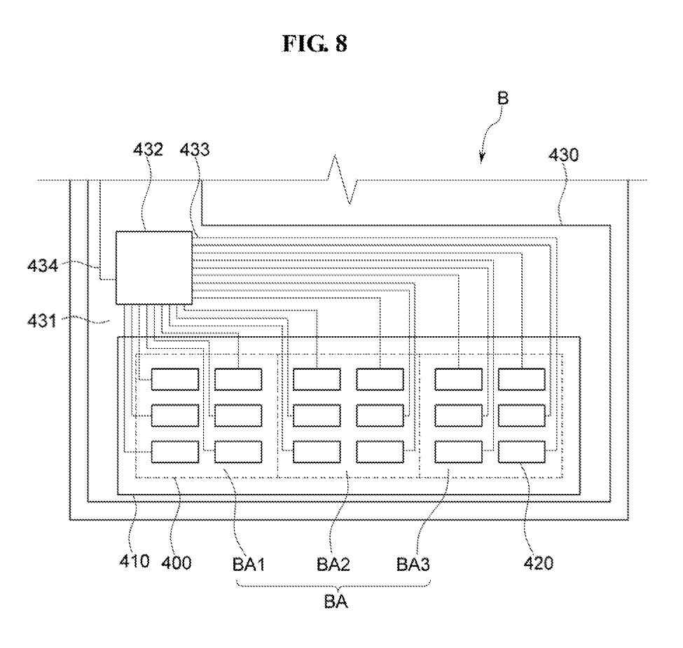

Hereinafter, a display device 20 according to an embodiment of the present invention will be described in detail with reference to FIGS. 7 and 8. The description of the display device 10 according to an embodiment of the present invention will be omitted from the description related to the display device 20.

FIG. 7 is a partial plan view illustrating a display device 20 according to an embodiment of the present invention, and FIG. 8 is a view enlarging portion B in FIG. 7.

According to an embodiment of the present invention, a button area BA may be disposed at one end portion of a display device 20.

For example, as illustrated in FIGS. 7 and 8, the button area BA may include a first button area BA, a second button area BA2, and a third button area BA3. In such an exemplary embodiment, the button area BA may be an area corresponding to a plurality of physical buttons, and each of the first button area BA1, the second button area BA2, and the third button area BA3 may be an area corresponding to one physical button. In other embodiments, the button area BA may be subdivided into a different number of sub areas.

According to an embodiment of the present invention, the pressure sensing driver disposed at a pressure sensing integrated circuit 432 detects a pressure sensor through which current flows, calculates the position where the pressure is applied, and outputs pressure sensing information such as the position of the pressed sensor. For example, the pressure sensing driver may calculate the position of the pressure, and determine which of the first button area BA, the second button area BA2, and the third button area BA3 the pressed portion is located at.

According to an embodiment of the present invention, the height difference compensating unit 450 may be disposed in an area other than the button area BA.

However, embodiments of the present invention are not limited thereto. In an exemplary embodiment, the button area BA may have an area substantially equal to an area of the display area DA, and the plurality of pressure sensing units 400 may be disposed on a same plane over the entire surface of the display area DA.

As set forth hereinabove, a display device according to one or more embodiments may accurately and efficiently calculate the position where pressure is applied by including a plurality of pressure sensors.

While the present invention has been illustrated and described with reference to the embodiments thereof, it will be apparent to those of ordinary skill in the art that various changes in form and detail may be formed thereto without departing from the spirit and scope of the present invention.

What is claimed is:

1. A display device comprising:
a display panel having a display area and a non-display area;
a window disposed on one surface of the display panel;
a touch sensing unit disposed between the display panel and the window;
a pressure sensing unit disposed on another surface of the display panel and comprising a plurality of pressure sensors spaced apart from each other; and
a pressure sensing driver configured to receive a signal detected from the pressure sensing unit and to output pressure sensing information.

2. The display device of claim 1, further comprising a flexible printed circuit board that comprises a plurality of first wirings connecting the plurality of pressure sensors and the pressure sensing driver,
wherein the pressure sensing driver is disposed on the flexible printed circuit board.

3. The display device of claim 2, wherein the flexible printed circuit board overlaps the plurality of pressure sensors.

4. The display device of claim 2, further comprising a protective layer disposed between the pressure sensing unit and the display panel and overlapping the flexible printed circuit board.

5. The display device of claim 1, wherein the pressure sensing driver is configured to detect a pressure sensor to which a pressure is applied among the plurality of pressure sensors and calculate a position to which the pressure is applied.

6. The display device of claim 1, wherein the pressure sensing unit overlaps at least a part of the display area.

7. The display device of claim 1, wherein the pressure sensing unit overlaps a button area of the display area.

8. The display device of claim 1, further comprising a height difference compensating unit disposed at an area other than a button area.

9. The display device of claim 1, wherein each of the plurality of pressure sensors comprises:
a first sensing electrode;
a second sensing electrode opposing the first sensing electrode; and
an elastic member disposed between the first sensing electrode and the second sensing electrode, and
wherein each of the plurality of pressure sensors is configured to output a current signal to the pressure sensing driver.

10. The display device of claim 9, wherein one of the first sensing electrode and the second sensing electrode is unitarily formed, and the other is formed comprising a plurality of electrodes.

11. The display device of claim 1, wherein each of the plurality of pressure sensors has an area substantially equal to or less than about 25 mm².

12. The display device of claim 9, wherein the elastic member comprises one of an elastic pad, a double-sided adhesive foam pad, and a spring.

13. The display device of claim 1, further comprising a case accommodating the display panel, the touch sensing unit, and the pressure sensing unit.

14. A display device comprising:
a display panel having a display area and a non-display area;
a pressure sensing unit comprising a plurality of pressure sensors spaced apart from each other; and
a pressure sensing driver connected to the pressure sensing unit,
wherein each of the plurality of pressure sensors has an area substantially equal to or less than about 25 mm².

15. The display device of claim 14, wherein at least two of the plurality of pressure sensors that are adjacent to each other are configured to output a current signal substantially simultaneously.

16. The display device of claim 14, wherein the pressure sensing driver is configured to detect a pressure sensor to which a pressure is applied among the plurality of pressure sensors and calculate a position to which the pressure is applied.

17. The display device of claim 14, wherein the pressure sensing driver is configured to calculate a position to which pressure is applied based on a magnitude of a current signal output from the plurality of pressure sensors.

18. The display device of claim 14, further comprising a flexible printed circuit board that comprises a plurality of first wirings connecting the plurality of pressure sensors and the pressure sensing driver,
wherein the pressure sensing driver is disposed on the flexible printed circuit board.

19. The display device of claim 14, wherein each of the plurality of pressure sensors comprises:
a first sensing electrode;
a second sensing electrode opposing the first sensing electrode; and
an elastic member disposed between the first sensing electrode and the second sensing electrode, and
wherein each of the plurality of pressure sensors is configured to output a current signal to the pressure sensing driver.

20. The display device of claim 19, wherein one of the first sensing electrode and the second sensing electrode is unitarily formed, and the other is formed comprising a plurality of electrodes.
